(19) United States
(12) Patent Application Publication
(10) Pub. No.: US 2013/0131931 A1
(43) Pub. Date: May 23, 2013

(54) VEHICLE CONTROL SYSTEM AND VEHICLE CONTROL DEVICE

(71) Applicant: Masaki Mitsuyasu, Kawasaki-shi (JP)

(72) Inventor: Masaki Mitsuyasu, Kawasaki-shi (JP)

(73) Assignee: Toyota Jidosha Kabushiki Kaisha, Toyota-shi (JP)

(21) Appl. No.: 13/813,876

(22) PCT Filed: Aug. 9, 2010
(86) PCT No.: PCT/JP2010/063503

§ 371 Date: Feb. 1, 2013

(51) Int. Cl. B60W 30/00; B60W 10/10; B60W 10/06

(52) U.S. Cl. CPC B60W 30/00; B60W 10/06; B60W 10/10
USPC 701/48

(57) ABSTRACT

A vehicle control system includes a deceleration adjusting unit capable of adjusting deceleration of a vehicle with opening adjustment of an intake passage to an internal combustion engine which is a driving power source to drive the vehicle, power generation load adjustment of a power generation device to generate electric power using power of the internal combustion engine, and transmission ratio adjustment of a transmission to shift gears of power from the internal combustion engine; and a vehicle control device configured to adjust the deceleration by prioritizing the opening adjustment or the power generation load adjustment over the transmission ratio adjustment, when adjusting the deceleration by controlling the deceleration adjusting unit in accordance with an operation amount of braking/driving request operation during fuel-cut toward the internal combustion engine.

### FIELD

The present invention relates to a vehicle control system and a vehicle control device.

### BACKGROUND

As a traditional vehicle control system or a vehicle control device, for example, Patent Literature 1 discloses a deceleration control device for a vehicle which increases a power generation amount of a power generation device when fuel supply to an engine is cut. According to the deceleration control device for a vehicle, require deceleration required by a driver can be obtained by controlling deceleration of the vehicle with open-close operation of a throttle valve when a power generation amount is increased, for example.

### CITATION LIST

### Patent Literature

Patent Literature 1: Japanese Patent Application Laid-open No 11-107805

### SUMMARY

### Technical Problem

By the way, the abovementioned deceleration control device for a vehicle described in Patent Literature 1 is desired to actualize deceleration required by a driver more appropriately, for example.

To address the above issue, a purpose of the present invention is to provide a vehicle control system and a vehicle control device which can appropriately actualize deceleration required by a driver.

### Solution to Problem

In order to achieve the above mentioned object, a vehicle control system according to the present invention includes a deceleration adjusting unit capable of adjusting deceleration of a vehicle with opening adjustment of an intake passage to an internal combustion engine which is a driving power source to drive the vehicle, power generation load adjustment of a power generation device to generate electric power using power of the internal combustion engine, and transmission ratio adjustment of a transmission to shift gears of power from the internal combustion engine; and a vehicle control device configured to adjust the deceleration by prioritizing the opening adjustment or the power generation load adjustment over the transmission ratio adjustment, when adjusting the deceleration by controlling the deceleration adjusting unit in accordance with an operation amount of braking/driving request operation during fuel-cut toward the internal combustion engine.

Further, in the vehicle control system, it is possible to configure that the vehicle control device performs fuel-cut control of the internal combustion engine in a case that an accelerator operation amount which is the operation amount of the braking/driving request operation is larger than zero and smaller than or equal to a predetermined value, and adjusts the deceleration by controlling the deceleration adjusting unit in accordance with the accelerator operation amount.

Further, in the vehicle control system, it is possible to configure that the vehicle control device adjusts the deceleration in the descending priority order of the power generation load adjustment, the opening adjustment, and the transmission ratio adjustment.

Further, in the vehicle control system, it is possible to configure that the vehicle control device adjusts the deceleration in the descending priority order of the opening adjustment, the power generation load adjustment, and the transmission ratio adjustment.

Further, in the vehicle control system, it is possible to configure that the vehicle control device starts the deceleration adjustment with the opening adjustment or the power generation load adjustment and switches to the deceleration adjustment with the transmission ratio adjustment through a period in which the deceleration adjustment with the opening adjustment or the power generation load adjustment and the deceleration adjustment with the transmission ratio adjustment are overlapped.

Further, in the vehicle control system, it is possible to configure that the vehicle control device finishes the deceleration adjustment with the power generation load adjustment in a case of reaching a usage limit corresponding to a state of an electric power storage device which stores electric power generated by the power generation device when adjusting the deceleration with the power generation load adjustment, and switches to the deceleration adjustment with the opening adjustment or the transmission ratio adjustment.

In order to achieve the above mentioned object, a vehicle control device according to the present invention configured to adjust deceleration of a vehicle by controlling a deceleration adjusting unit capable of adjusting the deceleration with opening adjustment of an intake passage to an internal combustion engine which is a driving power source to drive the vehicle, power generation load adjustment of a power generation device to generate electric power using power of the internal combustion engine, and transmission ratio adjustment of a transmission to shift gears of power from the internal combustion engine, wherein the deceleration is adjusted by prioritizing the opening adjustment or the power generation load adjustment over the transmission ratio adjustment, when adjusting the deceleration by controlling the deceleration adjusting unit in accordance with an operation amount of braking/driving request operation during fuel-cut toward the internal combustion engine.

### Advantageous Effects of Invention

The vehicle control system and the vehicle control device according to the present invention have an effect that deceleration required by a driver can be actualized appropriately.

### BRIEF DESCRIPTION OF DRAWINGS

FIG. 1 is a schematic structural view of a vehicle to which a vehicle control system according to a first embodiment is applied.

FIG. 2 is a block diagram illustrating a schematic structure of a deceleration control unit according to the first embodiment.

FIG. 3 is a schematic view illustrating an example of correlation between request negative torque and respective operation areas of the deceleration adjusting unit according to the first embodiment.

FIG. 4 is an example of a map of a throttle fully-opened torque line under fuel-cut and a throttle fully-closed torque line under fuel-cut according to the first embodiment.

FIG. 5 is an explanatory time-chart of an example of control with an ECU according to the first embodiment.

FIG. 6 is an explanatory flowchart of an example of the control with the ECU according to the first embodiment.

FIG. 7 is an explanatory time-chart of an example of control with an ECU of a second embodiment.

FIG. 8 is an explanatory time-chart of an example of control with an ECU of a third embodiment.

FIG. 9 is an explanatory time-chart of an example of control with an ECU of a fourth embodiment.

### DESCRIPTION OF EMBODIMENTS

In the following, embodiments according to the present invention will be described in detail based on the drawings. Here, the embodiments are not intended to limit the present invention. Further, structural elements in the following embodiments include elements which are easily replaceable by a person skilled in the art or which are substantially the same.

### First Embodiment

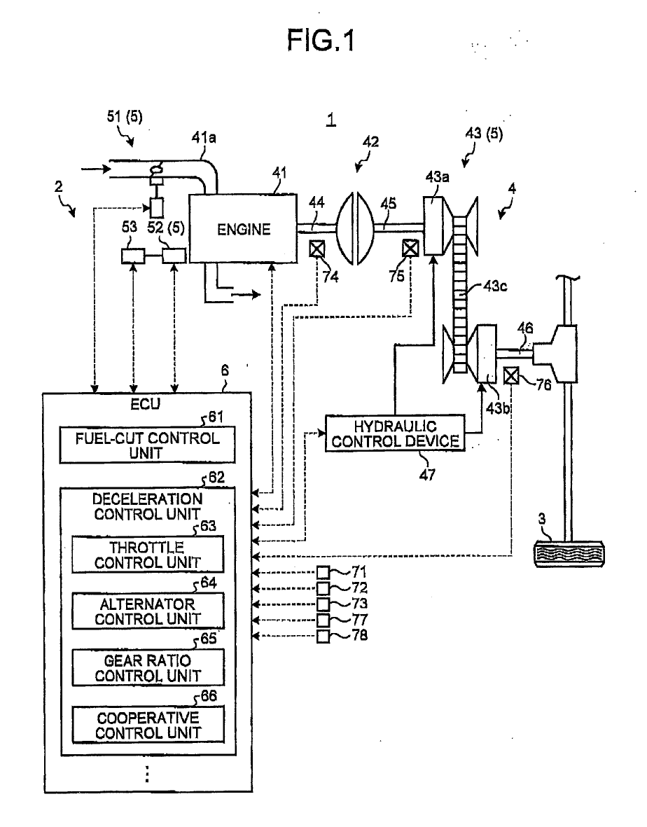

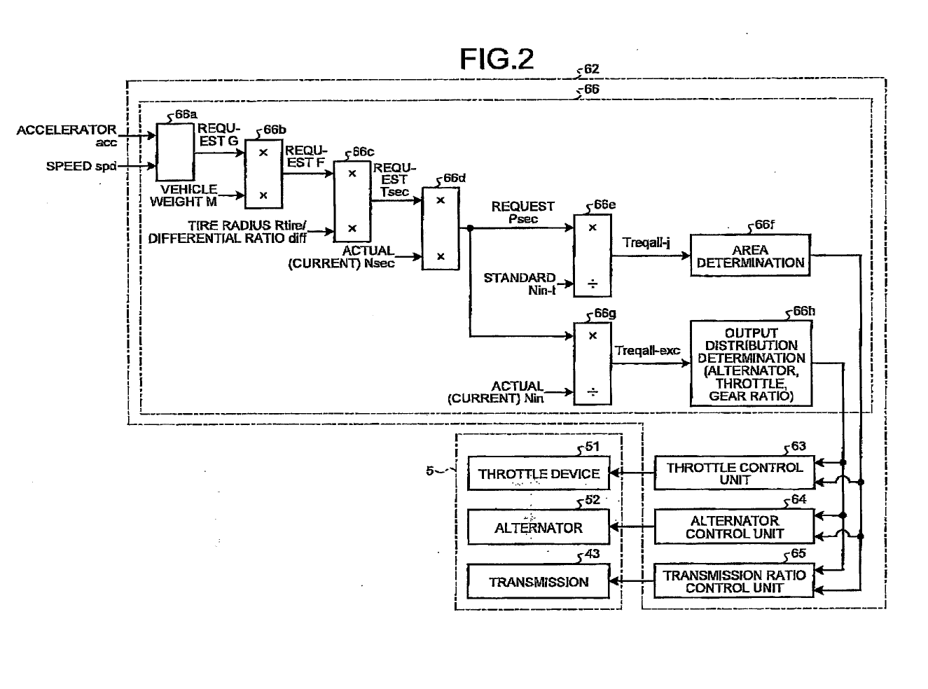

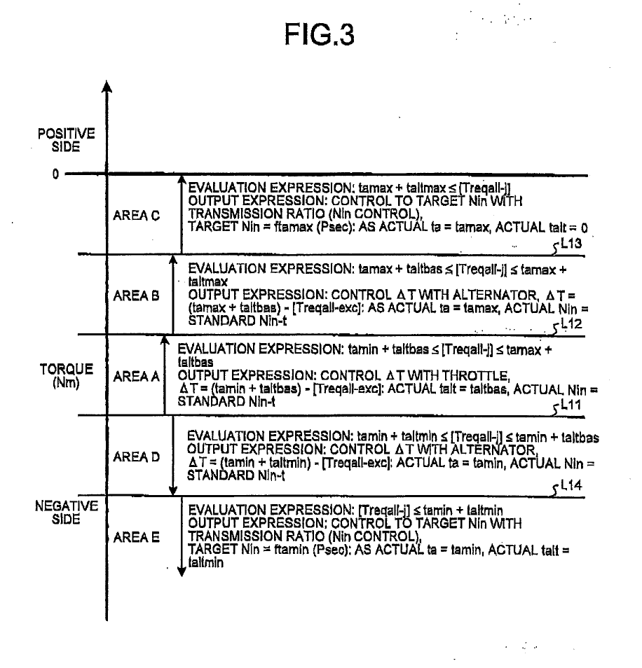

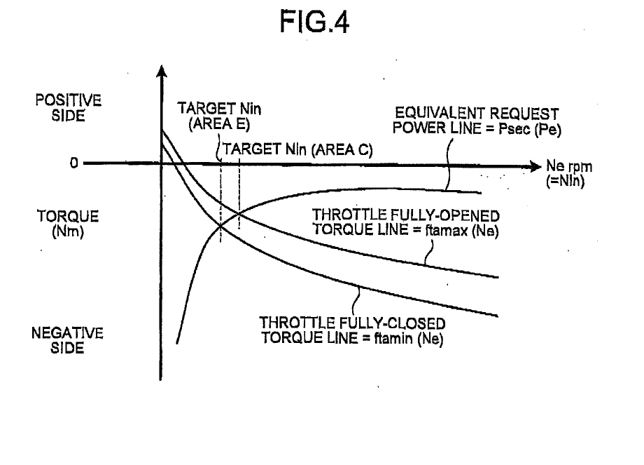

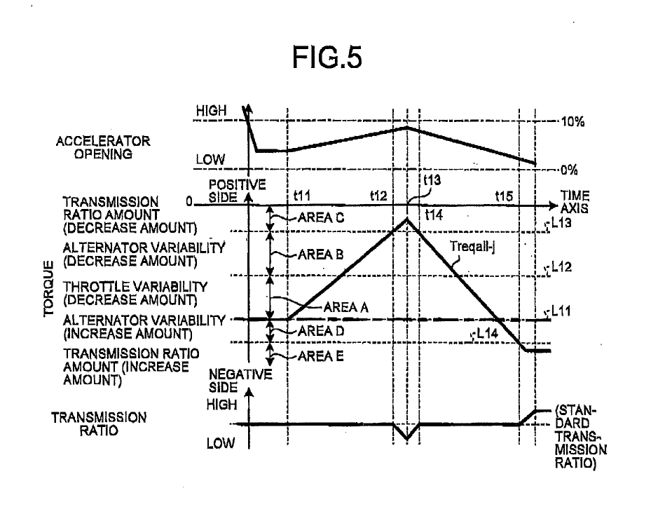

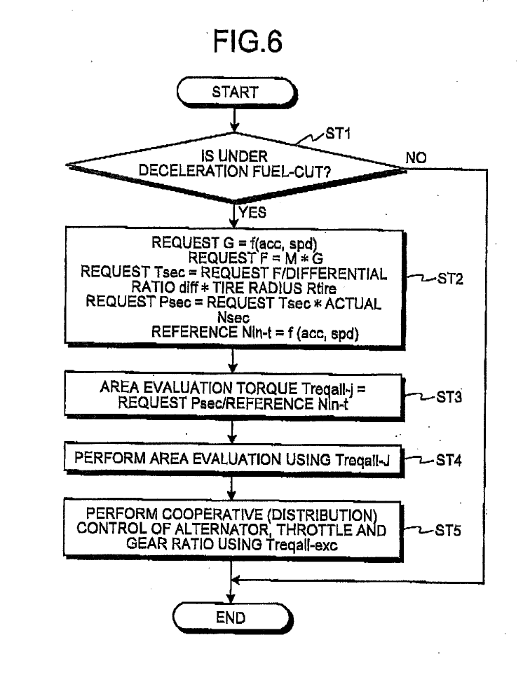

FIG. 1 is a schematic structural view of a vehicle to which a vehicle control system according to a first embodiment is applied. FIG. 2 is a block diagram illustrating a schematic structure of a deceleration control unit according to the first embodiment. FIG. 3 is a schematic view illustrating an example of corresponding relation between each operational area of the deceleration adjusting unit according to the first embodiment and request negative torque. FIG. 4 illustrates an example of a map of a throttle fully-opened torque line under fuel-cut and a throttle fully-closed torque line under fuel-cut, according to the first embodiment. FIG. 5 is an explanatory timing-chart of an example of control with an ECU according to the first embodiment. FIG. 6 is an explanatory flowchart of an example of the control, with the ECU according to the first embodiment.

As illustrated in FIG. 1, a vehicle control system of the present embodiment is a system to be mounted on a vehicle 2 for controlling the vehicle 2. The vehicle 2 includes an engine 41 as an internal combustion engine for forwarding as rotationally driving a drive wheel 3. Then, the vehicle control system 1 can vary deceleration exerted to the vehicle 2 into appropriate magnitude by controlling a deceleration adjusting unit 5 which is capable of adjusting the deceleration of the vehicle 2 during operation of fuel-cut control against the engine 41. Here, the deceleration is negative acceleration, in other words. Typically, unless otherwise noted, deceleration, enlarging denotes to enlarge an absolute value of deceleration, and typically, denotes to decrease acceleration in the negative side.

Specifically, the vehicle control system 1 includes a drive device 4, the deceleration adjusting unit 5, and an ECU 6 as a vehicle control device, as illustrated in FIG. 1. In the following, description is performed as the vehicle control device being structured with the ECU 6 which controls each part of the vehicle 2. However, not limited to the above, it is also possible that the vehicle control device and the ECU 6 are structured separately.

The drive device 4 is provided with the engine 41 and is to rotationally drive the drive wheel 3 with the engine 41. More specifically, the drive device 4 is structured to include the engine 41, a torque converter 42, a transmission 43, and the like. According to the drive device 4, a crank shaft 44 as an internal combustion engine output shaft of the engine 41 and a transmission input shaft 45 of the transmission 43 are connected via the torque converter 42 and a transmission output shaft 46 of the transmission 43 is connected to the drive wheel 3 via a differential mechanism, a drive shaft, and the like.

The engine 41 being a drive power source (prime mover) to drive the vehicle 2 generates power to be exerted to the drive wheel 3 of the vehicle 2 as consuming fuel. The engine 41 is a thermometer through which fuel energy is output as being converted into mechanical work by combusting fuel with air in a combustion chamber. The engine 41 generates mechanical power (engine torque) at the crank shaft 44 in accordance with fuel combustion and is capable of outputting the mechanical power toward the drive wheel 3 from the crank shaft 44.

The torque converter 42 transmits power from the engine 41 to the transmission 43 as amplifying torque with a fluid transmitting portion or at unchanged torque via a lock-up clutch. The transmission 43 shifts the power from the engine 41. The transmission 43 is capable of transmitting rotational power (rotational output) from the engine 41 input to the transmission input shaft 45 to the transmission output shaft 46 as varying speed at a predetermined transmission ratio and outputting from the transmission output shaft 46 toward the drive wheel 3. Here, as an example, the transmission 43 exemplifies a belt-type continuously variable transmission (CVT) which is structured to include a primary pulley 43a coupled with the transmission input shaft 45, a secondary pulley 43b coupled with the transmission output shaft 46, a belt 43c routed between the primary pulley 43a and the secondary pulley 43b, and the like. The transmission 43 performs transmitting operation in accordance with pressure of operational oil (operational fluid) supplied from a hydraulic control device 47 and continuously varies the transmission ratio which corresponds to a ratio between revolution number of the primary pulley 43a (primary revolution number) and revolution number of the secondary pulley 43b (secondary revolution number).

The drive device 4 structured as described above can transmit the power generated by the engine 41 to the drive wheel 3 via the torque converter 42, the transmission 43, and the like. As a result, drive force (N) is generated at a contact area of the drive wheel 3 with a road surface and the vehicle 2 can be driven accordingly.

The deceleration adjusting unit 5 is capable of adjusting deceleration of the vehicle 2 with opening adjustment of an intake passage 41a to the engine 41, power generation load adjustment of an alternator 52 as a power generation device to generate power using the power of the engine 41, and transmission ratio adjustment of the transmission 43 which shifts gears of the power from the engine 41. The deceleration adjusting unit 5 is structured to include a throttle device 51 as an opening adjustment portion, a power generation device being the alternator 52 as a power generation load adjustment portion, and the transmission 43 as a transmission ratio adjustment portion. The transmission 43 forms a part of the deceleration adjusting unit 5 as well while forming a part of the drive device 4.

The throttle device 51 adjusts an intake air amount taken into the combustion chamber of the engine 41 as adjusting throttle opening corresponding to opening of the intake passage (e.g., intake pipe) 41a of the engine 41 by performing open/close driving of a valve arranged at the intake passage (e.g., intake pipe) 41a. Thus, the throttle device 51 adjusts deceleration of the vehicle 2 with opening adjustment of the throttle opening. The throttle device 51 can increase and decrease intake loss (pumping loss) due to intake resistance at the intake passage of the engine 41 by increasing and decreasing the throttle opening. The intake loss functions as friction being rotational resistance of the crank shaft 44 during operation of the engine 41. Therefore, during occurrence of the intake loss, engine friction torque occurs as torque in the direction to stop the rotating crank shaft 44.

For example, the throttle device 51 can decrease the intake loss and decrease the engine friction torque by enlarging the throttle opening. Then, for example, in a state that engine torque generated by the engine 41 (output torque generated by the power source) is constant, engine shaft torque substantially output from the engine 41 (total output torque of the engine 41 actually input to the torque converter 42 side from the engine 41 side) becomes large with increase of the throttle opening and decrease of the engine friction torque. The throttle device 51 being capable of adjusting the throttle opening in a range from the fully-closed (0%) to the fully-opened (100%) can adjust deceleration exerted to the vehicle 2 as adjusting torque transmitted to the drive wheel 3 in accordance therewith.

The alternator 52 is a driven machine which is operated as receiving mechanical power from the engine 41 and which outputs the mechanical power as being converted to predetermined work. The alternator 52 is arranged at the engine 41 and generates power as being driven using the power of the engine 41. The alternator 52 charges a battery 53 being an electric storage device while supplying electric power to electric loads of the vehicle 2 via an inverter and the like. The alternator 52 is coupled with the crank shaft 44 via a pulley, a belt, and the like and is driven as being interlocked with rotation of the crank shaft 44 accordingly. The alternator 52 is capable of adjusting a power generation amount, in other words, a power generation load, via a regulator and the like.

Then, the alternator 52 adjusts deceleration of the vehicle 2 with power generation load adjustment. At the time of power generation, the alternator 52 exerts alternator load torque being torque corresponding to the power generation load to the crank shaft 44 via a pulley, a belt and the like. The alternator load torque is torque in the direction to stop the rotating crank shaft 44. The alternator 52 adjusts magnitude of the alternator load torque owing to adjusting the power generation amount, that is, the power generation load.

For example, the alternator 52 can decrease the alternator load torque by lessening the power generation load as lessening the power generation amount. Then, for example, in a state that engine torque generated by the engine 41 is constant, the engine shaft torque substantially output from the engine 41 becomes large with decrease of the power generation load and decrease of the alternator load torque. Accordingly, the alternator 52 can adjust deceleration exerted to the vehicle 2 as adjusting torque transmitted to the drive wheel 3.

The transmission 43 adjusts deceleration of the vehicle 2 with transmission ratio adjustment of the transmission ratio which can be expressed by “primary revolution number/secondary revolution number”. For example, the transmission 43 can increase engine braking as enlarging rotational resistance of the engine 41 by performing gear shifting to increase the transmission ratio (downshifting). In contrast, the transmission 43 can decrease engine braking as lessening rotational resistance of the engine 41 by performing gear shifting to decrease the transmission ratio (upshifting). Accordingly, the transmission 43 can adjust deceleration exerted to the vehicle 2 as adjusting torque transmitted to the drive wheel 3.

The ECU 6 is to control driving of each part of the vehicle 2 such as the drive device 4, the deceleration adjusting unit 5, and the like. The ECU 6 is an electric circuit based on a known microcomputer including a CPU, ROM, RAM and an interface.

The ECU 6 is electrically connected to a variety of sensors and detection devices arranged at respective part of the vehicle 2 such as an accelerator sensor 71 which detects an operation amount of an accelerator pedal (accelerator operation amount) by a driver, a brake sensor 72 which detects an operation amount of a brake pedal (brake operation amount) by the driver, a throttle sensor 73 which detects the throttle opening, an engine revolution number sensor 74 which detects engine revolution (engine rotation speed), a primary pulley rotation sensor 75 which detects revolution number of the primary pulley 43a (primary revolution number), a secondary pulley rotation sensor 76 which detects revolution number of the secondary pulley 43b (secondary revolution number), a vehicle speed sensor 77 which detects vehicle speed being driving speed of the vehicle 2, and an electric power state detection device 78 which detects a variety of electric power states such as alternator current, auxiliary load current for air-conditioner, a headlight and the like, battery voltage, and a battery power storage state SOC, for example. Typically, the accelerator pedal operation amount being accelerator opening, for example, and the brake pedal operation amount being pedal force of the brake pedal, for example, correspond to an operation amount of braking/driving request operation which is required for the vehicle 2 by a driver.

The ECU 6 is electrically connected with a fuel injection device of the engine 41, an ignition device, the throttle device 51, a regulator of the alternator 52, an inverter of the battery 53 and the like and is connected to the transmission 43 and the like via the hydraulic control device 47. The ECU 6 receives input of electric signals corresponding to detection results detected by a variety of sensors and controls driving of the above portions as outputting drive signals to the respective portions in accordance with the input detection results. For example, at the time of normal driving, the ECU 6 adjusts an intake air amount to the engine 41 as adjusting the throttle opening based on the accelerator opening, the vehicle speed, and the like, controls a fuel injection amount in accordance with variation thereof, and controls output of the engine 41 as adjusting a mixture amount filled into the combustion chamber. Further, the ECU 6 performs shift change control of the transmission 43 as adjusting the transmission ratio, typically, the input revolution number to the transmission 43, based on the accelerator opening, the vehicle speed, and the like.

Then, the ECU 6 adjusts deceleration of the vehicle 2 as controlling the deceleration adjusting unit 5 in accordance with the operation amount of the braking/driving request operation for the engine 41 under fuel-cut. At that time, for adjusting deceleration of the vehicle 2 as controlling the deceleration adjusting unit 5, the ECU 6 adjusts deceleration by performing cooperative control as the opening adjustment and the power generation load adjustment being prioritized over the transmission ratio adjustment. Accordingly, deceleration requested by a driver is appropriately actualized.

Specifically, the ECU 6 is structured to include a fuel-cut control unit 61 and a deceleration control unit 62 on a functionally conceptual basis, as illustrated in FIG. 1.

The fuel-cut control unit 61 performs fuel-cut control of the engine 41 under predetermined conditions. The fuel-cut control unit 61 performs the fuel-cut control to stop supplying fuel to the combustion chamber of the engine 41 in a case that the accelerator operation amount being the operation amount of the braking/driving request operation, that is, the acceleration opening detected by the accelerator sensor 71, is larger than zero and smaller than or equal to a predetermined value. The fuel cut control unit 61 performs the fuel-cut control to cut fuel supplying to the minimum as controlling the fuel injection device of the engine 41, for example, in a case that the accelerator opening is larger than zero and smaller than or equal to 10%.

The deceleration control unit 62 enables to obtain request deceleration requested by a driver by performing deceleration FC-time negative torque control (negative torque control) to adjust deceleration of the vehicle 2 by controlling the deceleration adjusting unit 5 under fuel-cut toward the engine 41 in accordance with an operation amount of braking/driving request operation, that is, the accelerator opening being the accelerator operation amount here. Typically, when the torque converter 42 is in a lock-up state and being under fuel-cut at deceleration of the vehicle 2, the deceleration control unit 62 performs the deceleration FC-time negative torque control in accordance with the accelerator opening and the like. The deceleration control unit 62 enlarges deceleration as enlarging an absolute value of negative torque to be exerted to the drive wheel 3, for example, with closing of the accelerator opening to zero, in other words, with increase of the request deceleration requested by a driver under deceleration fuel-cut. In this manner, the deceleration control unit 62 sets deceleration of the vehicle 2 to magnitude corresponding to the accelerator opening.

Then, in the deceleration EC-time negative torque control, the deceleration control unit 62 controls deceleration of the vehicle 2 as controlling negative torque to be exerted to the drive wheel 3 by performing cooperative control as the opening adjustment and the power generation load adjustment being prioritized over the transmission ratio adjustment. That is, in the deceleration FC-time negative torque control, the deceleration control unit 62 performs cooperative control to cause the throttle control as the opening adjustment control and the alternator control as the power generation load adjustment control to be prioritized over the transmission ratio control as the transmission ratio adjustment control. Here, the deceleration control unit 62 is structured to include a throttle control unit 63, an alternator control unit 64, a transmission ratio control unit 65, and a cooperative control unit 66.

The throttle control unit 63 performs the throttle control to adjust engine friction torque and to adjust deceleration to be exerted to the vehicle 2 as adjusting the throttle opening by actuating the throttle device 51 as the opening adjustment under operation of fuel-cut control. In the throttle control of the deceleration FC-time negative torque control, the throttle control unit 63 adjusts actual throttle opening on the basis of standard throttle opening under operation of fuel-cut control. Typically, the standard throttle opening is throttle opening at the time when the throttle device 51 is fully-closed (0%). With the standard throttle opening, the throttle device 51 can flow, to the combustion chamber, air on the order to be capable of maintaining idling revolution at the time of idling operation and the like of the engine 41. At that time, the engine 41 is to output the minimum engine torque on the order to be capable of maintaining idling revolution.

In the throttle control of the deceleration FC-time negative torque control, the throttle control unit 63 decreases engine friction torque, decreases negative torque, and decreases deceleration of the vehicle 2, for example, by increasing the actual throttle opening on the basis of the standard throttle opening. In other words, in the throttle control of the deceleration FC-time negative torque control, the throttle control unit 63 decreases deceleration of the vehicle 2 as decreasing actual engine friction torque by increasing the actual throttle opening on the basis of standard engine friction torque generated at the standard throttle opening, for example.

The alternator control unit 64 performs the alternator control to adjust alternator load torque and to adjust deceleration to be exerted to the vehicle 2 as adjusting the power generation load by adjusting the power generation amount of the alternator 52 as the power generation load adjustment under operation of fuel-cut control. In the alternator control of the deceleration FC-time negative torque control, the alternator control unit 64 adjusts an actual power generation amount (power generation load) on the basis of a standard power generation amount (standard power generation load) under operation of fuel-cut control. Typically, the standard power generation amount is a necessary power generation amount which is defined in accordance with electric power request for normally actuating a variety of auxiliaries such as air-conditioner under operation of fuel-Cut control, electric power balance of the battery 53, and a current electric power consumption situation.

In the alternator control of the deceleration FC-time negative torque control, the alternator control unit 64 decreases alternator negative torque, decreases negative torque, and decreases deceleration of the vehicle 2, for example, by decreasing the actual power generation amount on the basis of the standard power generation amount. In other words, in the alternator control of the deceleration FC-time negative torque control, the alternator control unit 64 decreases deceleration of the vehicle 2 as, decreasing actual alternator load torque by decreasing the actual power generation amount on the basis of standard alternator load torque generated at the time of generating the standard power generation amount, for example.

The transmission ratio control unit 65 performs the transmission ratio control to adjust engine braking and to adjust deceleration to be exerted to the vehicle 2 by adjusting the transmission ratio as activating the transmission 43 as the transmission ratio adjustment under operation of fuel-cut control. In the transmission ratio control of the deceleration FC-time negative torque control, the transmission ratio control unit 65 adjusts actual input revolution number (corresponds to the primary revolution number) to the transmission 43 by adjusting an actual transmission ratio on the basis of standard input revolution number corresponding to a standard transmission ratio under operation of fuel-cut control. Typically, the standard transmission ratio and the standard input revolution number are a transmission ratio and input revolution number of the transmission 43 which are defined in accordance with a normal target transmission ratio and target input revolution number to be used under operation of fuel-cut control. Typically, the normal target transmission ratio and target input revolution number are a transmission ratio and input revolution number of a target which are determined with a variety of known methods based on current actual vehicle speed, accelerator opening and the like with much importance on drivability.

In the transmission ratio control of the deceleration FC-time negative torque control, the transmission ratio control unit 65 lessens rotation resistance of the engine 41, decreases engine braking, and decreases deceleration of the vehicle 2, for example, by decreasing the actual input revolution number to the transmission 43 as decreasing the actual transmission ratio (i.e., upshifting) on the basis of the standard input revolution number. In other words, in the transmission ratio control of the deceleration FC-time negative torque control, the transmission ratio control unit 65 decreases deceleration of the vehicle 2 as decreasing the actual engine braking by decreasing the actual transmission ratio and decreasing the input revolution number on the basis of standard engine braking generated at the time of the standard input revolution number, for example.

In the deceleration FC-time negative torque control under operation of fuel-cut control, the cooperative control unit 66 performs cooperative control of the throttle control, the alternator control, and the transmission ratio control. Here, compared to the transmission ratio control, the throttle control and the alternator control in the deceleration FC-time negative torque control have a tendency that an adjustment range of deceleration is relatively narrow while responsiveness thereof is relatively high. Meanwhile, compared to the throttle control and the alternator control, the transmission ratio control in the deceleration FC-time negative torque control has a tendency that an adjustment range of deceleration is relatively wide while responsiveness thereof is relatively low.

In consideration of the abovementioned tendencies of the throttle control, the alternator control, and the transmission ratio control in the deceleration FC-time negative torque control, the ECU 6 of the present embodiment appropriately actualize deceleration requested by a driver owing to that the cooperative control unit 66 performs the cooperative control in which the throttle control or the alternator control are prioritized over the transmission ratio control. Regarding negative torque allocation in the deceleration FC-time negative torque control with the deceleration adjusting unit 5, owing to that a high response part is assigned to the throttle control or the alternator control and a low response part is assigned to the transmission ratio control, the ECU 6 can adjust deceleration of the vehicle 2 at high response and in a long term as the whole deceleration FC-time negative torque control, for example. Accordingly, deceleration required by a driver can be actualized appropriately.

Typically, the cooperative control unit 66 determines a control target of the deceleration adjusting unit 5 for adjusting deceleration of the vehicle 2 in accordance with request deceleration and the like required by a driver under deceleration fuel-cut and determines an actual output value to be actually output to the control target. As an example, as exemplified in FIG. 2, the cooperative control unit 66 determines the control target of the deceleration adjusting unit 5 in the deceleration FC-time negative torque control and determines the actual output value using area evaluation torque Treqall-j and actual output value determination torque Treqall-exc.

The area evaluation torque Treqall-j is request negative torque for area evaluation calculated based on request deceleration (or request power) from a driver and the standard input revolution number (or standard transmission ratio). The actual output value determination torque Treqall-exc is request negative torque for output value calculation calculated as based on request deceleration (or request power) from a driver and real actual input revolution number (or actual transmission ratio). Owing to that the cooperative control unit 66 determines the control target of the deceleration adjusting unit 5 in the deceleration FC-time negative torque control and determines the actual output value using the area evaluation torque Treqall-j and the actual output value torque Treqall-exc and determines the actual output value, the ECU 6 can reliably actualize deceleration requested by a driver while preventing occurrence of hunting in the deceleration FC-time negative torque control.

Specifically, the ECU 6 previously stores, in a storage unit (not illustrated), correlation between the request negative torque corresponding to the request deceleration requested by a driver under deceleration fuel-cut and the respective operation areas of the respective devices structuring the deceleration adjusting unit 5, that is, the throttle device 51, the alternator 52, and the transmission 43 as having reference in a state that the transmission 43 is operated at the standard transmission ratio and the standard input revolution number. In other words, the operation area of the deceleration adjusting unit 5 is previously divided in accordance with magnitude of the request negative torque into an operation area at which deceleration is adjusted with operation of the throttle device 51, an operation area at which deceleration is adjusted with operation of the alternator 52, an operation area at which deceleration is adjusted with operation of the transmission 43, and the like. Then, the ECU 6 stores the correlation between the respective divided operation areas of the deceleration adjusting unit 5 and the request negative torque as a map, expression or the like in the storage unit (not illustrated). Here, the correlation between the request negative torque and the operation areas of the respective devices of the deceleration adjusting unit 5 is set so that the opening adjustment with the throttle device 51 and the power generation load adjustment with the alternator 52 are prioritized over the transmission ratio adjustment with the transmission 43.

Then, the cooperative control unit 66 evaluates the operation area of the deceleration adjusting unit 5 based on the correlation between the respective operation areas of the deceleration adjusting unit 5 and the request negative torque and the area evaluation torque Treqall-j and determines the operation area of the current deceleration adjusting unit 5 in accordance with the current area evaluation torque Treqall-j. Owing to evaluation that the current area evaluation torque. Treqall-j belongs to which operation area among the respective operation areas of the throttle device 51, the alternator 52, and the transmission 43, the cooperative control unit 66 determines the operational area of the current deceleration adjusting unit 5 and determines the control target which is caused to actually operate for adjusting deceleration of the vehicle 2.

In this manner, owing to that the operation area of the current deceleration adjusting unit 5 is determined using the area evaluation torque Treqall-j based on the standard input revolution number, the cooperative control unit 66 can prevent occurrence of hunting with the deceleration FC-time negative torque control.

Then, based on the actual output value determination torque Treqall-exc, the cooperative control unit 66 calculates the actual output value to be output to the control target of the deceleration adjusting unit 5 determined as described above for adjusting deceleration of the vehicle 2. In this manner, owing to that the actual output value (distribution amount) to be assigned to each device of the deceleration adjusting unit 5 is calculated using the actual output value determination torque Treqall-exc based on the actual input revolution number, deceleration required by a driver can be reliably actualized.

Subsequently, an example of a more-detailed structure of the deceleration control unit 62 as structured above will be described with reference to a block diagram of FIG. 2. The cooperative control unit 66 of the deceleration control unit 62 is structured to include a request G calculating unit 66a, a request F calculating unit 66b, a request Tsec calculating unit 66c, a′request Psec calculating unit 66d, an evaluation torque calculating unit 66e, an area evaluation unit 66f, an output determination torque calculating unit 66g, an output determining unit 66h and the like.

The request G calculating unit 66a calculates request deceleration (request acceleration) G requested for the vehicle 2 using a map and the like previously stored in the storage unit based on actual accelerator opening acc and actual vehicle speed slid which are detected by the accelerator sensor 71 and the vehicle speed sensor 77. The request F calculating unit 66b calculates request drive force F requested for the vehicle 2 based on the request deceleration G calculated by the request G calculating unit 66a and vehicle weight M of the vehicle 2 previously stored in the storage unit. The request F calculating unit 66b calculates the request drive force F as “F=M×G”, for example.

The request Tsec calculating unit 66c calculates request secondary torque Tsec required for the secondary pulley 43b at the output side of the transmission 43 based on the request drive force F calculated by the request F calculating unit 66b, a tire radius Rtire of the drive wheel 3, and a differential ratio diff of a differential gear (differential mechanism) previously stored in the storage unit. The request Tsec calculating unit 66c calculates the request secondary torque Tsec as “Tsec=F/(diff×Rtire)”, for example. The request Psec calculating unit 66d calculates request secondary power Psec requested for the secondary pulley 43b based on the request secondary torque Tsec calculated by the request Tsec calculating unit 66c and actual secondary revolution number Nsec (corresponds to output revolution number Nout of the transmission 43) detected by the secondary, pulley rotation sensor 76. The request Psec calculating unit 66d calculates the request secondary power Psec as “Psec=Tsec×actual Nsec”, for example. Here, the request secondary power Psec to which influences of loss at the transmission 43, power used at auxiliaries and the like are reflected corresponds to request engine power Pe required for the engine 41.

The evaluation torque calculating unit 66e calculates the area evaluation torque Treqall-j based on the request secondary power Psec (or the request engine power Pe) calculated by the request Psec calculating unit 66d and the abovementioned standard input revolution number Nin-t calculated based on the actual vehicle speed and the accelerator opening. The evaluation torque calculating unit 66e calculates the area evaluation torque Treqall-j as “Treqall-j”=Psec/standard Nin-t”, for example.

The area evaluation unit 66f determines the operation area of the current deceleration adjusting unit 5 corresponding to the current area evaluation torque Treqall-j based on the correlation between the respective operation areas of the deceleration adjusting unit 5 and request negative torque previously stored in the storage unit and the area evaluation torque Treqall-j calculated by the evaluation torque calculating unit 66e.

The output determination torque calculating unit 66g calculates the actual output value determination torque Treqall-exc based on the request secondary power Psec (or the request engine power Pe) calculated by the request Psec calculating unit 66d and the actual input revolution number Nin (corresponds to the primary revolution number Npri) detected by the primary pulley rotation sensor 15. The output determination torque calculating unit 66g calculates the actual output value determination torque Treqall-exc as “Treqall-exc=Psec/actual Nin”, for example.

Then, the output determining unit 66h calculates the actual output value for adjusting deceleration of the vehicle 2 to be output by the control target of the deceleration adjusting unit 5 based on the actual output value determination torque Treqall-exc.

The throttle control unit 63, the alternator control unit 64, and the transmission ratio control unit 65 controls the throttle device 51, the alternator 52, and the transmission 43 based on the operation area of the current deceleration adjusting unit 5 determined by the area evaluation unit 66f and each actual output value determined by the output determining unit 66h and adjusts deceleration of the vehicle 2 as performing the deceleration FC-time negative torque control.

Here, more specifically, the ECU 6 of the present embodiment adjusts deceleration of the vehicle 2 with the opening adjustment, the power generation load adjustment, and the transmission ratio adjustment being in descending order of priority. In the deceleration FC-time negative torque control, the ECU 6 adjusts deceleration of the vehicle 2 as performing control with the throttle control, the alternator control, and the transmission ratio control being in descending order of priority. That is, the correlation between the request negative torque stored in the storage unit and the operation areas of the respective devices structuring the deceleration adjusting unit 5 is set to be prioritized in the order of the opening adjustment with the throttle device 51, the power generation load adjustment with the alternator 52, and the transmission ratio adjustment with the transmission 43.

An example of the correlation between the request negative torque and the respective operation areas of the deceleration adjusting unit 5 of the present embodiment with reference to FIG. 3. In the drawing, the vertical axis denotes request torque and request torque at the lower side (negative side) from zero denotes so-called request negative torque. In the drawing, a boundary line L11 corresponds to negative torque at the standard throttle opening, the standard power generation amount, and the standard input revolution number under operation of fuel-cut control. A boundary line L12 corresponds to negative torque generated at the standard power generation amount and standard input revolution number in a state that the throttle opening is fully-opened. A boundary line L13 corresponds to negative torque generated at the standard input revolution number in a state that the throttle opening is fully-opened and the power generation amount is minimum. A boundary line L14 corresponds to negative torque generated at the standard input revolution number in a state that the throttle opening is fully-opened and the power generation amount is maximum.

In the drawing, an area at a side being close to zero with the boundary line L11 as a reference is an area in which an absolute value of the negative torque is decreased by the deceleration adjusting unit 5 to decrease deceleration (absolute value) of the vehicle 2. Area A between the boundary line L11 and the boundary line 12 is an operation area in which deceleration is adjusted to the decreasing side as increasing the throttle opening with operation of the throttle device 51. Area B between the boundary line L12 and the boundary line L13 is an operation area in which deceleration is adjusted to the decreasing side as decreasing the power generation amount (power generation load) with operation of the alternator 52 in a state that the throttle opening is fully-opened. Area C between the boundary line L13 and zero torque is an area in which deceleration is adjusted to the decreasing side as decreasing the transmission ratio, that is, as upshifting, with operation of the transmission 43 in a state that the throttle opening is fully-opened and the power generation amount (power generation load) is minimum.

Meanwhile, in the drawing, an area at a side being apart from zero with the boundary line L11 as a reference is an area in which an absolute value of the negative torque is increased by the deceleration adjusting unit 5 to increase deceleration (absolute value) of the vehicle 2. Area D between the boundary line L11 and the boundary line L14 is an operation area in which deceleration is adjusted to the increasing side as increasing the power generation amount with operation of the alternator 52 in a state that the throttle opening is fully-closed. Area E below the boundary line L14 is an operation area in which deceleration is adjusted to the increasing side as increasing the transmission ratio, that is, as downshifting, with operation of the transmission 43 in a state that the throttle opening is fully-closed and the power generation amount (power generation load) is maximum.

Then, for example, in a case that the area evaluation torque Treqall-j is in area A, the area evaluation unit 66f evaluates and determines such that it is the operation area in which deceleration is to be adjusted to the decreasing side as increasing the throttle opening with operation of the throttle device 51. In this case, the area evaluation unit 66f determines the operation area of the current deceleration adjusting unit 5 by using evaluation expressions and the like which are exemplified in FIG. 3, for example.

That is, the area evaluation unit 66f evaluates whether or not the area evaluation torque Treqall-j is in area A using an evaluation expression indicated as following expression (1), whether or not the area evaluation torque Treqall-j is in area B using an evaluation expression indicated as following expression (2), whether or not the area evaluation torque Treqall-j is in area C using an evaluation expression indicated as following expression (3), whether or not the area evaluation torque Treqall-j is in area D using an evaluation expression indicated as following expression (4), and whether or not the area evaluation torque Treqall-j is in area E using an evaluation expression indicated as following expression (5).

tamin+taltbas≦[Treqall-j]≦tamax+taltbas (1)

tamax+taltbas≦[Treqall-j]≦tamax+taltmax (2)

tamax+taltmax≦[Treqall-j] (3)

tamin+taltmin≦[Treqall-j]≦tamin+taltbas (4)

[Treqall-j]≦tamin+taltmin (5)

In the above expressions (1) to (5), “tamin” denotes negative torque corresponding to pumping loss when the throttle opening is fully-closed, that is, is the standard throttle opening, “taltbas” denotes negative torque corresponding to alternator load torque at the standard power generation amount, “tamax” denotes negative torque corresponding to pumping loss when the throttle opening is fully-opened, “taltmax” denotes negative torque corresponding to alternator load torque when the power generation amount is minimum”, and“taltmin” denotes negative torque corresponding to alternator load torque when the power generation amount is maximum.

Then, the output determining unit 66h calculates the actual output value by using output expressions and the like which are exemplified in FIG. 3, for example. That is, in a case that the area evaluation torque Treqall-j is in area A, the output determining unit 66h calculates differential torque ΔT for adjusting with operation of the throttle device 51 by using an output expression indicated as following expression (6). In a case that the area evaluation torque Treqall-j is in area B, the output determining unit 66h calculates differential torque ΔT for adjusting with operation of the alternator 52 by using an output expression indicated as following expression (7). In a case that the area evaluation torque Treqall-j is in area C, the output determining unit 66h calculates target Nin being target input revolution number for lessening the absolute value of the negative torque with operation of the transmission 43 by using an output expression indicated as following expression (8). In a case that the area evaluation torque Treqall-j is in area D, the output determining unit 66h calculates differential torque ΔT for adjusting with operation of the alternator 52 by using an output expression indicated as following expression (9). In a case that the area evaluation torque Treqall-j is in area E, the output determining unit 66h calculates target Nin being target input revolution number for enlarging the absolute value of the negative torque with operation of the transmission 43 by using an output expression indicated as following expression (10).

ΔT=(tamin+taltbas)−[Treqall-exc] (6)

(actual talt=taltbas, actual Nin=standard Nin-t)

ΔT=(tamax+taltbas)−[Treqall-exc] (7)

(actual ta=tamax, actual Nin=standard Nin-t)

Target Nin=ftamax(Psec) (8)

(actual ta=tamax, actual talt=0)

ΔT=(tamin+taltmin)−[Treqall-exc] (9)

(actual ta=tamin, actual Nin=standard Nin-t)

Target Nin=ftamin(Psec) (10)

(actual ta=tamin, actual talt−taltmin)

In above expressions (8) and (10), ftamax(Psec) and ftamin(Psec) denote target input revolution numbers calculated from the request secondary power Psec (or request engine power Pe) respectively with a torque line line ftamax(Ne) which indicates relation between the engine revolution number Ne (i.e., input revolution number Nin) at fully-opened throttle under fuel-cut and the negative torque and a torque line ftamin (Ne) which indicates relation between the engine revolution number Ne at fully-closed throttle under fuel-cut and the negative torque respectively exemplified in FIG. 4.

Then, the throttle control unit 63, the alternator control unit 64, and the transmission ratio control unit 65 controls the throttle device 51, the alternator 52, and the transmission 43 based on the respective actual output values determined by the output determining unit 66h to adjust deceleration of the vehicle 2 as performing the deceleration FC-time negative torque control. As a result, owing to that the'area evaluation unit 66f determines the operation area of the current deceleration control portion 5 and that the output determining unit 66h determines the actual output value, the ECU 6 can adjust deceleration of the vehicle 2 by performing control with the throttle control, the alternator control, and the transmission ratio'control being in descending order of priority in the deceleration FC-time negative torque control.

An example of control of the ECU 6 will be described with reference to the time-chart of FIG. 5. In FIG. 5, the horizontal axis denotes the time axis and the vertical axes denote the accelerator opening, the request negative torque, and the transmission ratio. In the drawing, the standard transmission ratio is illustrated as being constant expediently for easier understanding of explanation. However, actually, slight variation occurs in accordance with current actual vehicle speed, accelerator opening and the like.

When the accelerator opening detected by the accelerator sensor 71 is decreased to be larger than zero and smaller than or equal to 10%, the ECU 6 of the vehicle control system 1 performs fuel-cut control by controlling the fuel injection device of the engine 41. At that time, the actual throttle opening, the actual power generation amount, and the actual transmission ratio (corresponds to actual input revolution number) are maintained'respectively at the standard throttle opening, the standard power generation amount, and the standard transmission ratio (transmission ratio corresponding to the standard input revolution number). At that time, the area evaluation torque Treqall-j is on the boundary line L11.

Subsequently, for example, when the accelerator opening turns to be increased in a range being 10% or smaller at time t11, the area evaluation torque Treqall-j is increased to the side being close to zero with the boundary line L11 as a reference in accordance therewith.

In a case that the area evaluation'torque Treqall-j is in area A due to throttle variability (decrease amount), the ECU 6 increases the actual throttle opening against the standard throttle opening with operation of the throttle device 51 in accordance with the actual output value determination torque Treqall-exc in a state of being maintained at the standard generation amount and the standard transmission ratio, thereby adjusting deceleration of the vehicle 2 to the decreasing side.

When the accelerator opening continues to be further increased in the range being 10% or smaller and the area evaluation torque Treqall-j enters into area B due to alternator variability (decrease amount) as exceeding the line L12 in accordance therewith, the ECU 6 decreases the actual power generation amount against the standard power generation mount with operation of the alternator 52 in accordance with the actual output value determination torque Treqall-exc in a state that the throttle opening is fully-opened as being maintained at the standard transmission ratio, thereby adjusting deceleration of the vehicle 2 to the decreasing side.

When the accelerator opening continues to be further increased in the range being 10% or smaller and the area evaluation torque Treqall-j enters into area C due to the transmission ratio amount (decrease amount) as reaching the boundary line L13 at time t12 in accordance therewith, the ECU 6 decreases the actual transmission ratio against the standard transmission ratio with operation of the transmission 43, that is, is upshifted, in a state that the throttle opening is fully-opened and the power generation amount is minimum, thereby adjusting deceleration of the vehicle 2 to the decreasing side.

Subsequently, for example, when the accelerator opening turns to be decreased in the range being 10% or smaller at time t13, the area evaluation torque Treqall-j is decreased to the side being apart from zero in accordance therewith.

In a case that the area evaluation torque Treqall-j remains in area C, the ECU 6 increases the actual transmission ratio to be close to the standard transmission ratio with operation of the transmission 43, that is, is downshifted, in accordance with decrease of the accelerator opening in a state that the throttle opening is fully-opened and the power generation amount is minimum, thereby adjusting deceleration of the vehicle 2 to the increasing side.

When the accelerator opening continues to be further decreased in the range being 10% or smaller and the area evaluation torque Treqall-j enters into area B again as falling below the boundary line L13 at time t14 in accordance therewith, the ECU 6 increases the actual power generation amount to be close to the standard power generation amount with operation of the alternator 52 in accordance with the actual output value determination torque Treqall-exc in a state that the throttle opening is fully-opened as being maintained at the standard transmission ratio, thereby adjusting deceleration of the vehicle 2 to the increasing side.

When the accelerator opening continues to be further decreased in the range being 10% or smaller and the area evaluation torque Treqall-j enters into area A again as falling below the boundary line L12 in accordance therewith, the ECU 6 decreases the actual throttle opening to be close to the standard throttle opening with operation of the throttle device 51 in accordance with the actual output value determination torque Treqall-exc in a state of being maintained at the standard power generation amount and the standard transmission ratio, thereby adjusting deceleration of the vehicle 2 to the increasing side.

Further, when the accelerator opening continues to be further decreased in the range being 10% or smaller and the area evaluation torque Treqall-j enters into area D due to alternator variability (increase amount) as falling below the boundary line L11 in accordance therewith, the ECU 6 increases the actual power generation amount against the standard power generation amount with operation of the alternator 52 in accordance with the actual output value determination torque Treqall-exc in a state of being maintained at the standard throttle opening and the standard transmission ratio, thereby adjusting deceleration of the vehicle 2 to the increasing side.

When the accelerator opening continues to be further decreased in the range being 10% or smaller and the area evaluation torque Treqall-j enters into area E due to a transmission ratio amount (increase amount) as falling below the boundary line L14 in accordance therewith, the ECU 6 increases the actual transmission ratio against the standard transmission ratio with operation of the transmission 43, that is, is downshifted, in a state that the power generation amount is maximum as being maintained at the standard throttle opening, thereby adjusting deceleration of the vehicle 2 to the increasing side.

According to the above-structured vehicle control system 1 and the ECU 6, even in a case that deceleration requested by a driver cannot be actualized as adjusting deceleration of the vehicle 2 even with the throttle opening adjustment and the power generation load adjustment under fuel-cut, the deceleration requested by the driver can be actualized owing to that the cooperative control is appropriately performed by combining the transmission ratio control. Then, according to the vehicle control system 1 and the ECU 6, owing to that deceleration of the vehicle 2 is adjusted as the opening adjustment and the power generation load adjustment being prioritized over the transmission ratio control, the deceleration of the vehicle 2 can be adjusted at high response and in a long term as the whole deceleration FC-time negative torque control, for example, while enabling to provide the deceleration to meet a driver's request. Accordingly, deceleration requested by a driver can be appropriately actualized.

More specifically, according to the above-structured vehicle control system 1 and the ECU 6, since deceleration of the vehicle 2 is adjusted with the throttle opening adjustment, the power generation load adjustment, and the transmission ratio adjustment being in descending order of priority under fuel-cut, a period in which the power generation load of the alternator 52 is deviated from the standard power generation load can be shortened in the deceleration FC-time negative torque control. Accordingly, long-term deceleration Control due to the alternator 52 can be performed while appropriately maintaining the power generating state and the power storing state.

Next, an example of control of the ECU 6 will be described with reference to the flowchart of FIG. 6. Here, control routines thereof are repeatedly executed in control cycles of several milli-seconds to several tens of milli-seconds (hereinafter, being the same unless otherwise specified).

First, the ECU 6 determines whether or not the vehicle 2 is currently under deceleration fuel-cut (ST1).

In a case that it is determined as being currently under deceleration fuel-cut of the vehicle 2 (“Yes” in ST1), the ECU 6 sequentially calculates the request deceleration (request acceleration) G, the request drive force F, the request secondary torque Tsec, the request secondary power Psec, the standard input revolution number Nin-t, and the like based on detection results and the like of the variety of sensors and detection devices arranged at respective parts of the vehicle 2 (ST2).

Next, the ECU 6 calculates the area evaluation torque Treqall-j based on the request secondary power Psec and the standard input revolution number Nin-t calculated in ST2 (ST3).

Next, the ECU 6 evaluates the operation area of the deceleration adjusting unit 5 based on the area evaluation torque Treqall-j calculated in ST3 and the correlation between the respective operation areas of the deceleration adjusting unit 5 and the request negative torque previously stored in the storage unit (ST4).

Next, the ECU 6 calculates the actual output value determination torque Treqall-exc based on the request secondary power Psec and the actual input revolution number Nin and calculates the actual output value to be output to the deceleration adjusting unit 5 for adjusting deceleration of the vehicle 2 based on the actual output value determination torque Treqall-exc. Then, the ECU 6 performs the cooperative (distribution) control of the throttle device 51, the alternator 52, and the transmission 43 based on the actual output value in accordance with the operation area of the current deceleration adjusting unit 5 determined in ST4 and adjusts deceleration of the vehicle 2 as performing the deceleration FC-time negative torque control (ST5). Thus, the current control cycle is completed and it proceeds to the next control cycle.

In a case that it is determined as not being under deceleration fuel-cut in ST1 (“No” in ST1), the current control cycle is completed and it proceeds to the next control cycle.

According to the ECU 6 of the above-mentioned embodiment, the ECU 6 adjusts deceleration of the vehicle 2 by controlling the deceleration adjusting unit 5 with the opening adjustment of the intake passage 41a to the engine 41 being a driving power source to drive the vehicle 2, the power generation load adjustment of the alternator 52 to generate electric power using power of the engine 41, and the transmission ratio adjustment of the transmission to vary speed of the power from the engine 41. Here, the deceleration is adjusted as prioritizing the opening adjustment or the power generation load adjustment over the transmission ratio adjustment when adjusting the deceleration by controlling the'deceleration adjusting unit 5 in accordance with an operation amount of braking/driving request operation under fuel-cut toward the engine 41. The vehicle control system 1 according to the above-mentioned embodiment includes the abovementioned deceleration adjusting unit 5 and the abovementioned ECU 6. According to the vehicle control system 1 and the ECU 6, deceleration of the vehicle 2 can be adjusted at high response, in a long term, and with wide adjustment width as the whole deceleration FC-time negative torque control, for example.

Accordingly, deceleration requested by a driver can be appropriately actualized.

### Second Embodiment

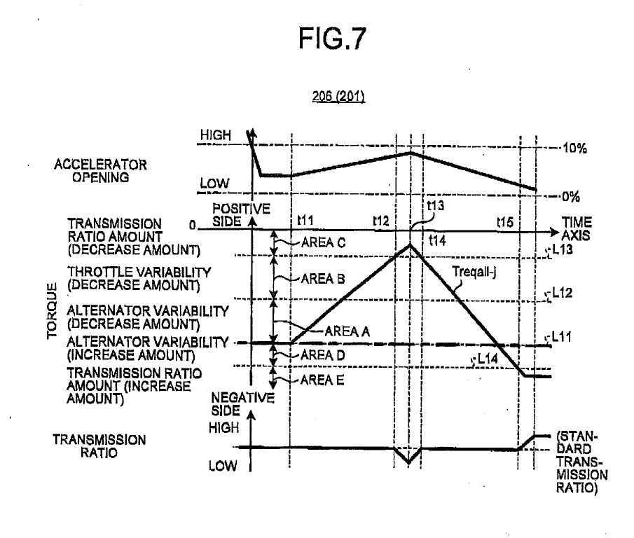

FIG. 7 is an explanatory time-chart of an example of control with an ECU according to a second embodiment. A vehicle control system and a vehicle control device according to the second embodiment differ from those of the first embodiment in priority order at the time when deceleration of a vehicle is adjusted by a deceleration adjusting unit. Further, duplicate description of structures, operations and effects being common to the abovementioned embodiment will be skipped to the extent possible as appropriately referring to FIG. 1 for a main structure (being the same for embodiments described below).

A vehicle control system 201 of the present embodiment includes an ECU 206 as the vehicle control device. For example, as exemplified in FIG. 7, the ECU 206 of the present embodiment adjusts deceleration of the vehicle 2 with the power generation load adjustment, the opening adjustment, and the transmission ratio adjustment being in descending order of priority. In the deceleration FC-time negative torque control, the ECU 206 adjusts deceleration of the vehicle 2 as performing control with the alternator control, the throttle control, and the transmission ratio control being in the descending order of priority. That is, the correlation between the request negative torque stored in the storage unit and the operation areas of the respective devices structuring the deceleration adjusting unit 5 is set to be prior in the order of the power generation load adjustment with the alternator 52, the opening adjustment with the throttle device 51, and the transmission ratio adjustment with the transmission 43.

Being different from the boundary line L12 (see FIG. 5) of the first embodiment, a boundary line L22 between area A and area B of the present embodiment corresponds to negative torque generated at the standard throttle opening and standard input revolution number in a state that the power generation amount (power generation load) is minimum. Then, in the present embodiment, area A between the boundary line L11 and the boundary line L22 is an operation area in which deceleration is adjusted to the decreasing side as decreasing the power generation amount (power generation load) with operation of the alternator 52. Area B between the boundary line L22 and the boundary line L13 is an operation area in which deceleration is adjusted to the decreasing side as increasing the throttle opening with operation of the throttle device 51 in a state that the power generation amount (power generation load) is minimum.

According to the above-structured vehicle control system 201 and the ECU 206, since deceleration of the vehicle 2 is adjusted with the power generation load adjustment, the throttle opening adjustment, and the transmission ratio adjustment being in descending order of priority under fuel-cut, the alternator 52 capable of performing activation control in higher response and higher accuracy can be used more preferentially than the throttle device 51 in the deceleration FC-time negative torque control. As a result, according to the vehicle control system 201 and the ECU 206, the deceleration of the vehicle 2 can be adjusted at higher response and higher accuracy as the whole deceleration FC-time negative torque control, for example, while enabling to provide the deceleration to meet a driver's request. Accordingly, deceleration requested by a driver can be appropriately actualized.

Further, the vehicle control system 201 and the ECU 206 can suppress, to the extent possible, deceleration adjustment with the throttle opening adjustment of the throttle device 51 which has a possibility to cause a shock at the time when returning from the fuel-cut control.

According to the vehicle control system 201 and the ECU 206 of the abovementioned embodiment, the ECU 206 adjusts deceleration with the power generation load adjustment, the opening adjustment, and the transmission ratio adjustment being in the order of priority. Therefore, according to the vehicle control system 201 and the ECU 206, deceleration of the vehicle 2 can be adjusted at higher response and higher accuracy while suppressing torque fluctuation at the time when returning from fuel-cut control. Accordingly, deceleration required by a driver can be actualized more appropriately.

### Third Embodiment

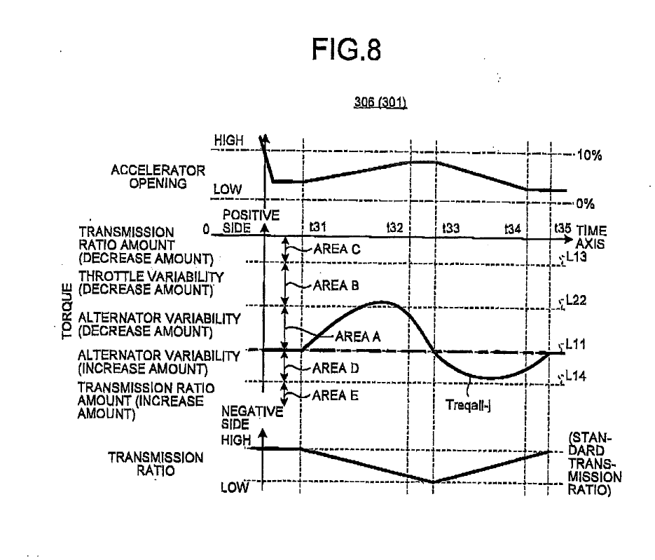

FIG. 8 is an explanatory time-chart of an example of control with an ECU according to a third embodiment. A vehicle control system and a vehicle control device according to the third embodiment differ from those of the second embodiment in that the power generation load adjustment, the opening adjustment, and the transmission ratio adjustment are overlapped when adjusting vehicle deceleration with the deceleration adjusting unit.

A vehicle control system 301 of the present embodiment includes an ECU 306 as the vehicle control device. For example, as exemplified in FIG. 6, the ECU 306 of the present embodiment adjusts deceleration of the vehicle 2 as the power generation load adjustment, the opening adjustment, and the transmission ratio adjustment are overlapped while being configured to adjust the deceleration as the opening adjustment and the power generation load adjustment being prioritized over the transmission ratio adjustment. The ECU 306 performs the deceleration FC-time negative torque control as starting deceleration adjustment with high response control (alternator control or throttle control) due to the throttle device 51 or the alternator 52 being a high response device in the deceleration adjusting unit 5 and overlapping low response control (transmission ratio control) due to the transmission 43 being a low response device compared thereto. Then, as being eventually switched from the high response control to the low response control, distribution of the high response device becomes to zero. That is, the ECU 306 performs control of that deceleration control is started with the throttle opening control or the power generation load adjustment prior to the transmission ratio adjustment and that the transmission ratio adjustment is started to be overlapped with the opening adjustment or the power generation load adjustment to be the transmission ratio control when completing the deceleration control.

As the time-chart exemplified in FIG. 8, when the accelerator opening turns to be increased in the range being 10% or smaller at time t31, for example, the ECU 306 starts deceleration adjustment with the throttle opening adjustment or the power generation load adjustment. Here, the ECU 306 prioritizes the power generation load adjustment with the alternator 52 over the throttle opening adjustment with the throttle device 51. However, the above may be reversed. According to the ECU 306, in a case that the area evaluation torque Treqall-j is in area A due to the alternator variability (decrease amount), the actual power generation amount is decreased against the standard power generation amount with operation of the alternator 52 being a high response device. When the area evaluation torque Treqall-j enters into area B due to throttle variability (decrease amount), the actual throttle opening is increased against the standard throttle opening with operation of the throttle device 51 being a high response device. According to the above, deceleration of the vehicle 2 is adjusted to the decreasing side.

At that time, the ECU 306 starts gear shifting to decrease the actual transmission ratio, that is, upshifting, against the standard transmission ratio at predetermined gear shift speed with operation of the transmission 43 being a low response device. Accordingly, deceleration of the vehicle 2 is adjusted to the decreasing side. The predetermined gear shift speed may be previously-set constant gear shift speed or may be gear shift speed corresponding to a drive state.

Then, the ECU 306 adjusts the actual throttle opening and the actual power generation amount to be close to the standard throttle opening and the standard power generation amount having a period in which deceleration adjustment due to the opening adjustment or the power generation load adjustment and deceleration adjustment due to the transmission ratio adjustment are overlapped, and then, switched to deceleration adjustment due to the transmission ratio adjustment eventually.

During the above, the present embodiment basically adopts the area evaluation torque Treqall-j and the actual output value determination torque Treqall-exc from which the increase/decrease amount of the actual negative torque due to the transmission ratio adjustment of the transmission 43 is subtracted and the above is assigned to the throttle opening adjustment due to the throttle device 51 and the power generation load adjustment due to the alternator 52.

Subsequently, for example, when the accelerator opening turns to be decreased in the range being 10% or smaller at time t33 after time t32, deceleration adjustment due to the power generation load adjustment is started. When the area evaluation torque Treqall-j enters into area D due to alternator variability (increase amount), the ECU 306 increases the actual power generation amount against the standard power generation amount with operation of the alternator 52 being a high response device, thereby adjusting deceleration of the vehicle 2 to the increasing side.

At that time, the ECU 306 starts gear shifting to increase the actual transmission ratio, that is, downshifting, against the standard transmission ratio at predetermined gear shift speed with operation of the transmission 43 being a low response device. Accordingly, deceleration of the vehicle 2 is adjusted to the increasing side. Then, the ECU 306 decreases the actual power generation amount to be close to the standard power generation amount having a period in which deceleration adjustment due to the power generation load adjustment and deceleration adjustment due to the transmission ratio adjustment are overlapped, and then, switched to deceleration adjustment due to the transmission ratio adjustment eventually.

Then, for example, when the accelerator opening becomes constant in the range being 10% or smaller at time t34, the actual throttle opening, the actual power generation amount, and the actual transmission ratio becomes to the standard throttle opening, the standard power generation amount, and the standard transmission ratio respectively in the standard state subsequently at time t35. Accordingly, deceleration of the vehicle 2 becomes to standard deceleration under fuel-cut control.

According to the vehicle control system 301 and the ECU 306 of the abovementioned embodiment, the ECU 306 starts deceleration adjustment with the opening adjustment or the power generation load adjustment and switches to deceleration adjustment with the transmission ratio adjustment having a period in which the deceleration adjustment with the opening adjustment or the power generation load adjustment and the deceleration adjustment with the transmission ratio adjustment are overlapped. Therefore, according to the vehicle control system 301 and the ECU 306, burdens of the throttle device 51 and the alternator 52 can be reduced in adjustment of deceleration of the vehicle 2 under fuel-cut. As a result, according to the vehicle control system 301 and the ECU 306, it is possible to appropriately maintain a power generating state and a power storing state while shortening a period in which the power generation load of the alternator 52 is deviated from the standard power generation load. Further, it is possible to adjust deceleration of the vehicle 2 at high response, in a long term, and with wide adjustment width while suppressing torque fluctuation at the time when returning from fuel-cut control. Accordingly, deceleration requested by a driver can be actualized more appropriately.

### Fourth Embodiment

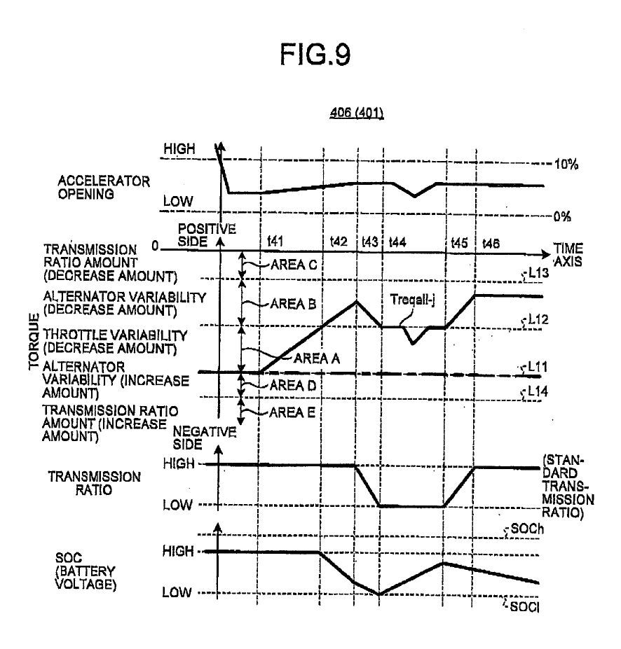

FIG. 9 is an explanatory time-chart of an example of control with an ECU according to a forth embodiment. A vehicle control system and a vehicle control device according to the fourth embodiment differ from those of the first embodiment in that vehicle deceleration is adjusted in accordance with a state of an electric storage device.

A vehicle control system 401 of the present embodiment includes an ECU 406 as the vehicle'control device. For example, as exemplified in FIG. 9, during deceleration adjustment with the power generation load adjustment, the ECU 406 of the present embodiment finishes the deceleration adjustment with the power generation load adjustment in a case of reaching a usage limit corresponding to a state of the battery 53 and switches to deceleration adjustment with the opening adjustment or the transmission ratio adjustment.

The cooperative control unit 66 of the ECU 406 estimates an alternator usable limit corresponding to a state of the battery 53. When a state of the alternator 52 is currently in a state of being in the alternator usable limit, the cooperative control is performed with the alternator control in the inter-deceleration-FC negative as applying full performance of the alternator 52. In contrast, when the state of the alternator 52 is currently in a state of exceeding the alternator usable limit or being in the vicinity of the limit, the cooperative control unit 66 performs the cooperative control as limiting performance of the alternator 52 in the alternator control of the deceleration FC-time negative torque control while the actual power generation amount (actual power generation load) of the alternator 52 is returned to the standard power generation amount (standard power generation load).

In this case, the cooperative control unit 66 estimates the alternator usable limit based on a variety of detection results detected by the electric power state detection device 78.

For example, the cooperative control unit 66 calculates alternator usable time Trest as a limit evaluation value to estimate and evaluate the alternator usable limit based on the battery power storage state SOC (e.g., value corresponding to a cumulative amount or the like of an alternator charge-discharge amount) detected by the electric power state detection device 78, alternator current Ialt, auxiliary load current IO and the like. The cooperative control unit 66 calculates battery charge current Ib with following expression (11), for example.

Ib=Ialt−IO (11)

Then, the cooperative control unit 66 calculates ΔSOC which is a leeway SOC at the time of the estimation with following expressions (12) and (13), for example. In expressions (12) and (13), “SOCh” denotes a previously-set upper limit of the SOC, “SOCl” denotes a previously-set lower limit of the SOC, and “actual SOC” denotes a current actual SOC.

ΔSOC=SOCh−actual SOC(when Ib≧0) (12)

ΔSOC=SOCl−actual SOC(when Ib<0) (13)

Then, the cooperative control unit 66 calculates the alternator usable time Trest at the time of estimation with following expressing (14).

Trest=ΔSOC/Ib (14)

The cooperative control unit 66 performs comparison between the alternator usable time Trest and specified time (threshold value) which is set previously against the alternator usable time Trest. In a case that the alternator usable time Trest is equal to or longer than the specified time, the cooperative control unit 66 evaluates that the current state of the alternator 52 is a state as being in the alternator usable limit. In a case that the alternator usable time is shorter than the specified time, the cooperative control unit 66 evaluates that the current state of the alternator 52 is in a state of exceeding the alternator usable limit or being in the vicinity of the limit.

As illustrated in a time-chart exemplified in FIG. 9, for example, when the accelerator opening turns to be increased in a range being 10% or smaller at time t41, the ECU 406 increases the actual throttle opening against the standard throttle opening with operation of the throttle device 51 in a case that the area evaluation torque Treqall-j is in area A due to throttle variability (decrease amount). When the area evaluation torque Treqall-j enters into area B due to alternator variability (decrease amount), the ECU 406 decreases the actual power generation amount against the standard power generation amount with operation of the alternator 52. Owing to the above, deceleration of the vehicle 2 is adjusted to the decreasing side.

Then, according to the vehicle control system 401, the battery power storage state SOC (battery voltage) is decreased after time t42 by the decreasing amount of the actual power generation amount due to the alternator 52, so that the actual SOC is closed to the SOCl being the lower limit. When the alternator usable time Trest becomes shorter than a first previously-set specified time at time t43, the ECU 406 finishes the deceleration adjustment with the power generation load adjustment as returning the actual power generation amount of the alternator 52 to the standard power generation amount. The ECU 406 compensates the adjustment amount of deceleration with the power generation load adjustment by switching to deceleration adjustment with the throttle opening or the transmission ratio adjustment, and here, to deceleration adjustment with the transmission ratio adjustment of the transmission 43. Then, the ECU 406 performs deceleration adjustment with the throttle opening adjustment and the transmission ratio adjustment at time t44 and later.

Then, according to the vehicle control system 401, the battery power storage state SOC is increased and the actual SOC becomes apart from the SOCl being the lower limit at time t44 and later by the returning amount of the actual power generation amount with the alternator 52 to the standard power generation amount.

Subsequently, when the alternator usable time Trest becomes to a second previously-set specified time (e.g., a period longer than the first specified time) or longer at time t45, the ECU 406 decreases anew the actual power generation amount with the alternator 52 against the standard power generation amount, restarts the deceleration adjustment with the power generation load adjustment, and finishes the deceleration adjustment with the transmission ratio adjustment of the transmission 43 as returning to the actual transmission ratio to the standard transmission ratio. That is, in this example, the ECU 406 performs the deceleration adjustment with the throttle opening adjustment and the transmission ratio adjustment from time t44 to time t45. Then, the ECU 406 performs the deceleration adjustment anew with the throttle'opening adjustment, the power generation load adjustment, and the transmission ratio adjustment at time t46 and later.

According to the vehicle control system 401 and the ECU 406 according to the abovementioned embodiment, during deceleration adjustment with the power generation load adjustment, the ECU 406 finishes the deceleration adjustment with the power generation load adjustment in a case of reaching a usage limit corresponding to a state of the battery 53 which stores electric power generated by the alternator 52 and switches to deceleration adjustment with the opening adjustment or the transmission ratio adjustment. Therefore, according to the vehicle control system 401 and the ECU 406, deceleration required by a driver can be actualized more appropriately while utilizing performance of the alternator 52 being a high response and high accuracy device in the deceleration FC-time negative torque control to a maximum extent.

Here, not limited to the above-mentioned embodiments, the vehicle control system and the'vehicle control device according to each abovementioned embodiment of the present invention may be modified variously within the scope of the claims. The vehicle control system and the vehicle control device according to the present embodiment may be structured as plurally combining the abovementioned embodiments.

The abovementioned cooperative control unit 66 may estimate the alternator usable limit based on battery voltage which is detected by the electric power state detection device 78, for example. In this case, the cooperative control unit 66 simply evaluates whether the current state of the alternator 52 is a state being within the alternator usable limit in accordance with whether or not a current real actual battery voltage is between upper limit battery voltage Vbu and lower limit battery voltage Vbl as previously-set battery voltage limit values by using the actual battery voltage as a limit evaluation value for estimation and evaluation of the alternator usable limit.

The abovementioned transmission 43 may adopt a variety of known structures, such as a stepped automatic transmission (AT), a toroidal-type continuously variable transmission (CVT), a multi-mode manual transmission (MMT), a sequential manual transmission (SMT), and a dual clutch transmission (DCT).

In the above description, the cooperative control unit 66 determines the control target of the deceleration adjusting unit 5 for adjusting deceleration of the vehicle 2 by using the area evaluation torque Treqall-j and the actual output value determination torque Treqall-exc and determines the actual output value to be actually output to the control target of the deceleration adjusting unit 5. Here, a method of the cooperative control is not limited to the abovementioned method as long as the opening adjustment and the power generation load adjustment are prioritized to the transmission ratio adjustment when adjusting deceleration of the vehicle 2 in the deceleration FC-time negative torque control.

### INDUSTRIAL APPLICABILITY

As described above, the vehicle control system and the vehicle control device according to the present invention are suitable for being applied as a vehicle control system and a vehicle control device to be mounted on a variety of vehicles.

### STANDARD SIGNS LIST

1, 201, 301, 401 Vehicle control system
2 Vehicle
3 Driving wheel
5 Deceleration adjusting unit
6, 206, 306, 406 ECU (Vehicle control device
41 Engine (Internal combustion engine)
41a Intake passage
43 Transmission
51 Throttle device
52 Alternator (Power generation device)
53 Battery (Electric power storage device)

1. A vehicle control system comprising:
a deceleration adjusting unit capable of adjusting deceleration of a vehicle with opening adjustment of an intake passage to an internal combustion engine which is a driving power source to drive the vehicle, power generation load adjustment of a power generation device to generate electric power using power of the internal combustion engine, and transmission ratio adjustment of a transmission to shift gears of power from the internal combustion engine; and
a vehicle control device configured to adjust the deceleration by controlling the deceleration adjusting unit in accordance with an operation amount of braking/driving request operation during fuel-cut toward the internal combustion engine and prioritizing the opening adjustment or the power generation load adjustment over the transmission ratio adjustment.

2. The vehicle control system according to claim 1, wherein
the vehicle control device performs fuel-cut control of the internal combustion engine in a case that an accelerator operation amount which is the operation amount of the braking/driving request operation is larger than zero and smaller than or equal to a predetermined value, and adjusts the deceleration by controlling the deceleration adjusting unit in accordance with the accelerator operation amount.

3. The vehicle control system according to claim 1, wherein
the vehicle control device adjusts the deceleration in the descending priority order of the power generation load adjustment, the opening adjustment, and the transmission ratio adjustment.

4. The vehicle control system according to claim 1, wherein
the vehicle control device adjusts the deceleration in the descending priority order of the opening adjustment, the power generation load adjustment, and the transmission ratio adjustment.

5. The vehicle control system according to claim 1, wherein
the vehicle control device starts the deceleration adjustment with the opening adjustment or the power generation load adjustment and switches to the deceleration adjustment with the transmission ratio adjustment through a period in which the deceleration adjustment with the opening adjustment or the power generation load adjustment and the deceleration adjustment with the transmission ratio adjustment are overlapped.

6. The vehicle control system according to claim 1, wherein
the vehicle control device finishes the deceleration adjustment with the power generation load adjustment in a case of reaching a usage limit corresponding to a state of an electric power storage device which stores electric power generated by the power generation device when adjusting the deceleration with the power generation load adjustment, and switches to the deceleration adjustment with the opening adjustment or the transmission ratio adjustment.

7. A vehicle control device configured to adjust deceleration of a vehicle by controlling a deceleration adjusting unit capable of adjusting the deceleration with opening adjustment of an intake passage to an internal combustion engine which is a driving power source to drive the vehicle, power generation load adjustment of a power generation device to generate electric power using power of the internal combustion engine, and transmission ratio adjustment of a transmission to shift gears of power from the internal combustion engine, wherein
the vehicle control device adjusts the deceleration by controlling the deceleration adjusting unit in accordance with an operation amount of braking/driving request operation during fuel-cut toward the internal combustion engine and prioritizing the opening adjustment or the power generation load adjustment over the transmission ratio adjustment.

8. The vehicle control system according to claim 2, wherein
the vehicle control device adjusts the deceleration in the descending priority order of the power generation load adjustment, the opening adjustment, and the transmission ratio adjustment.

9. The vehicle control system according to claim 2, wherein
the vehicle control device adjusts the deceleration in the descending priority order of the opening adjustment, the power generation load adjustment, and the transmission ratio adjustment.

10. The vehicle control system according to claim 2, wherein
the vehicle control device starts the deceleration adjustment with the opening adjustment or the power generation load adjustment and switches to the deceleration adjustment with the transmission ratio adjustment through a period in which the deceleration adjustment with the opening adjustment or the power generation load adjustment and the deceleration adjustment with the transmission ratio adjustment are overlapped.

11. The vehicle control system according to claim 2, wherein
the vehicle control device finishes the deceleration adjustment with the power generation load adjustment in a case of reaching a usage limit corresponding to a state of an electric power storage device which stores electric power generated by the power generation device when adjusting the deceleration with the power generation load adjustment, and switches to the deceleration adjustment with the opening adjustment or the transmission ratio adjustment.

12. The vehicle control system according to claim 3, wherein
the vehicle control device finishes the deceleration adjustment with the power generation load adjustment in a case of reaching a usage limit corresponding to a state of an electric power storage device which stores electric power generated by the power generation device when adjusting the deceleration with the power generation load adjustment, and switches to the deceleration adjustment with the opening adjustment or the transmission ratio adjustment.

13. The vehicle control system according to claim 4, wherein
the vehicle control device finishes the deceleration adjustment with the power generation load adjustment in a case of reaching a usage limit corresponding to a state of an electric power storage device which stores electric power generated by the power generation device when adjusting the deceleration with the power generation load adjustment, and switches to the deceleration adjustment with the opening adjustment or the transmission ratio adjustment.

14. The vehicle control system according to claim 5, wherein
the vehicle control device finishes the deceleration adjustment with the power generation load adjustment in a case of reaching a usage limit corresponding to a state of an electric power storage device which stores electric power generated by the power generation device when adjusting the deceleration with the power generation load adjustment, and switches to the deceleration adjustment with the opening adjustment or the transmission ratio adjustment.
